(19) United States
(12) Patent Application Publication
(10) Pub. No.: US 2007/0018581 A1
(43) Pub. Date: Jan. 25, 2007

(54) Discharge bulb and automobile headlamp

(75) Inventors: Yoichiro Domae, Shizuoka (JP); Naoki Uchida, Shizuoka (JP); Masaya Shido, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/489,560

(22) Filed: Jul. 20, 2006

(30) Foreign Application Priority Data
Jul. 20, 2005 (JP) P. 2005-209824

(51) Int. Cl. H01J 61/35

(52) U.S. Cl. 313/635

(57) ABSTRACT

A discharge bulb is equipped with an arc tube main unit including in a ceramic tube a discharge light emitting chamber where electrodes are provided face to face and a luminescent material is filled, with substantially the lower half of the outer peripheral surface of the ceramic tube covered by a light shielding ember. Light to be emitted from the ceramic tube is also emitted from the upper part and directed to the efficient reflecting surface of the reflector thus raising the luminance intensity of the headlamp. In the process of light distribution design of the reflector, the size of the rectangular light source image to be projected (stuck) along the cutoff line is made slimmer (narrower). By perform light distribution design (of the effective reflecting surface) so as to allow the maximum luminance part to approach the cutoff line, the hot zone gets closer to the cutoff line position with improved long distance visibility.

The present application claims foreign priority based on Japanese Patent Application No. P.2005-209824, filed on Jul. 20, 2005, the contents of which are incorporated herein by reference.

### BACKGROUND OF THE INVENTION

1. Field of the Invention

The present invention relates to a discharge bulb equipped with a ceramic arc tube in which electrodes are provided face to face and a luminescent material is filled, and an automobile headlamp equipped with the discharge bulb as a light source.

2. Related Art

As shown in FIG. 9, a discharge bulb as a light source of an automobile headlamp includes an arc tube 1 composed of a glass arc tube main unit 2 and shroud glass 4 welded integrally, the arc tube 1 integrally assembled to a synthetic resin insulating base 9 located behind and fixed/supported in a form extending forward. To be more specific, the rear end of the arc tube 1 (arc tube main unit 2) is grasped and fixed to the front side of the insulating base 9 via a metallic member 5. The front end of the arc tube 1 (arc tube main unit 2) is supported by a lead support 6 as an energizing path extending forward from the insulating base 9. A sign 6a represents an insulating cylinder into which the lead support 6 is inserted.

The arc tube main unit 2 has a structure that both ends of a glass tube are sealed and a closed glass bulb 2a in which aluminescent material (such as a metal halide) is filled together with a starting rare gas and electrodes are provided face to face is formed substantially at the center of the glass tube in longitudinal direction. The arc tube main unit 2 emits light with electric discharge between counter electrodes. On the outer surface of the cylindrical shroud glass 4 with the UV cut effect integrally welded to the arc tube main unit 2 is arranged a light shielding film 7 for controlling light distribution used to form sharp cutoff lines while shielding part of the light directed to the effective reflecting surface 8a of the reflector 8 for controlling reflection of light emitted from the arc tube main unit 2. A sign 8b represents a bulb insert hole arranged on the reflector 8.

The glass arc tube main unit 2 has a problem that the metal halide filled inside the glass tube accelerates corrosion of the glass tube and blacking phenomena and devitrification prevent proper light distribution and the service life of the tube is not so long.

As described in JP-A-2001-076677 (refer to FIG. 10), a ceramic arc tube main unit 110 was proposed where both ends of a cylindrical ceramic tube 120 are sealed via a cylindrical insulator 130 and a discharge light emitting chamber s in which electrodes 140, 140 are provided face to face and a luminescent material is filled together with a staring rare gas is formed inside the ceramic tube 120. The ceramic tube 120 is stable against a metal halide and has a longer service life than a glass tube.

As shown in FIG. 11, in JP-A-2004-362978, a ceramic arc tube main unit 110A is proposed that seals a discharge light emitting chamber s by jointing amolybdenum pipe 135 to a ceramic tube 120 and the rear end of an electrode 140 inserted into the a molybdenum pipe 135 whose tip protrudes into the discharge light emitting chamber s is jointed (welded) to the rear end of the molybdenum pipe 135. The shroud glass 4 is sealed to lead wires 118a, 118b guided from the front and rear end of the ceramic tube arc tube main unit 110A. As shown in FIG. 12, a discharge bulb equipped with the ceramic tube arc tube main unit 110A has its rear end grasped and fixed to the front side of the insulating base 9 via a metallic member 5 and has its front end lead wire supported by the lead support 6 as an energizing path extending forward from the insulating base 9, same as the discharge bulb equipped with the glass arc tube main unit 2. Signs 3a, 3b shown in FIG. 12 represent a lamp body and a front cover that partition the lamp chamber of a headlamp. A sign 3c represents an extension reflector.

Whether the arc tube main unit is made of glass or ceramics, as shown in FIG. 12, in the case of an automobile headlamp that uses this type of discharge bulb as a light source, light L2 emitted from the lower half of the arc tube main unit is generally not effectively used as light for forming predetermined light distribution, because the light is vignetted by the lead support 6 or the cylinder 6a or because glare light is generated from reflection of light on the extension reflector 3c. By controlling the light L1 emitted from the upper half of the arc tube main unit without an obstacle to cause it to be reflected on the effective reflecting surface 8a of the reflector 8, predetermined light distribution of a low beam is formed.

As a result, the light L2 emitted downward from the arc tube main unit hardly contributes to formation of light distribution and is consumed uselessly. This fails to obtain the sufficient light distribution illumination (luminous intensity) of a headlamp with respect to power consumption.

In the case of a headlamp that uses a discharge bulb equipped with a ceramic tube arc tube main unit shown in the first and second related arts, only light distribution with poor long distance visibility where a hot zone is substantially below a cutoff line.

In the case of an automobile headlamp that uses a discharge bulb as a light source, distribution of a low beam is formed by way of an effective reflecting surface formed above the bulb arrangement position of the reflector. To design the effective reflecting surface, a rectangular light source image a corresponding to a ceramic tube 120 constituting an arc tube main unit is radially projected about a cutoff line elbow part on a light distribution screen disposed at a position frontward of the reflector. For example, the shape of an effective reflecting surface on the reflector for forming cutoff lines provided in close proximity to a position horizontal in lateral direction with respect to the arc tube main unit is designed, as shown by the signs A, C in FIG. 13, by projecting (sticking) the light source images a, a adjacent in the lateral direction (direction along the cutoff line) as a radial direction about the elbow part with part thereof overlaid one on the other along the cutoff line. The shape of an effective reflecting surface for forming laterally diffused light distribution provided above the effective reflecting surface for forming cutoff lines is designed, as shown by the sign B in FIG. 13, by projecting (sticking) the light source images a, a adjacent in a downward of slanting direction as a radial direction about the elbow part with part thereof overlaid one on the other. The light distribution pattern shown in FIG. 13 shows a light distribution pattern obtained when the reflecting surface is a rotational parabolic surface. In reality, light distribution patterns A1, B1, C1 in predetermined shapes without uneven light distribution is formed by diffusing the light source image a in a predetermined direction (mainly lateral direction) while forming a diffusion step on the reflecting surface.

In the headlamp that uses a ceramic tube arc tube main unit as a light source, light emitted from the ceramic tube 120 is diffused. Thus, as shown in FIG. 13, the maximum luminance part a1 corresponding to a discharge arc (section corresponding to an arc generated between electrodes) in the rectangular light source image a corresponding to the ceramic tube 120 is positioned substantially at the center of the rectangular light source image a having a width w. Design of the effective reflecting surface of the reflector to provide light distribution where the hot zone Hz position is in close proximity to the cutoff line CL position is not very successful. The hot zone Hz position is somewhat below the cutoff line CL thus worsening the long distance visibility.

The inventor has contemplated the following scenario. Covering the substantially lower half area of the arc tube main unit (ceramic tube 120) with a light shielding member having a function to reflect light toward its inner surface causes light outgoing downward from the arc tube main unit (ceramic tube 120) to be reflected on the light shielding member and emitted from the substantially upper half area of the arc tube main unit (ceramic tube 120) toward the effective reflecting surface 8a of the reflector 8, thereby increasing the light distribution illumination (luminous intensity) of the headlamp. In the process of light distribution design of the effective reflecting surface 8a of the reflector 8, the size of the rectangular light source image a to be projected (stuck) along the cutoff line CL with respect to the maximum luminance part al is made slimmer (narrower), that is, the width w of the rectangular light source image a is reduced. This makes it possible to perform light distribution design (of the effective reflecting surface 8a of the reflector 8) so as to allow the maximum luminance part a1 to approach the cutoff line CL. As a result, the hot zone Hz position gets closer to the cutoff line CL position with improved long distance visibility. The inventor prototyped a discharge bulb and verified its effect and found it effective. The inventor has thus made this application.

The invention has been accomplished in view of the related art problems and the inventor's findings. An object of the invention is to provide an discharge bulb effective in improving both the light distribution illumination (luminous intensity) and long distance visibility of an automobile headlamp.

### SUMMARY OF THE INVENTION

In accordance with one or more embodiments of the present invention, as a first aspect of the invention, a discharge bulb is provided with: a ceramic arc tube; a discharge light emitting chamber formed on the ceramic arc tube, wherein electrodes are provided face to face and a luminescent material is filled in the discharge light emitting chamber; and a light shielding member that covers at least substantially lower half of an outer peripheral surface of the ceramic tube constituting the ceramic arc tube and reflects light toward an inner surface.

The light shielding member to cover substantially the lower half of the outer peripheral surface of the ceramic tube may be a light shielding member mounted on the ceramic tube or a light shielding film formed in close contact with the ceramic tube described in a fourth aspect.

(Working effect) In a headlamp that uses an discharge bulb as a light source, the effective reflecting surface of a reflector is designed, as shown in FIG. 6, by projecting (sticking) a light source image a corresponding to the outer shape of an arc tube main unit (ceramic tube) radially about a cutoff line elbow part on a light distribution screen disposed at a position frontward of the reflector. The substantially lower part of the outer peripheral surface of the arc tube main unit (ceramic tube) is covered by a light shielding member so that the following working effects are obtained.

First, as shown in FIG. 7, the size of the rectangular light source image a to be projected (stuck) along cutoff lines with respect to the maximum luminance part a1 is made slimmer (narrower), that is, the width w1 of the rectangular light source image a is reduced (w1<w) . Further, the maximum luminance part a1 is positioned close to the upper edge of the rectangular light source image a. This makes it possible to perform light distribution design (of the effective reflecting surface of the reflector) so as to allow the maximum luminance part a1 to approach the cutoff lines. As a result, the light distribution hot zone gets closer to the cutoff line position (0.5 to 1.5D position).

Second, light emitted downward from the arc tube main unit (ceramic tube) is reflected on the light shielding member and is returned into the arc tube main unit and emitted from substantially the upper half area of the arc tube main unit (ceramic tube) not covered by the light shielding member. This increases the brightness of each rectangular light source image a thus adding to the luminous intensity of light distribution formed by the reflector. In other words, light emitted downward from the arc tube main unit (ceramic tube) that hardly contributes to formation of light distribution in the related art structure is emitted toward the effective reflecting surface of the reflector from substantially the upper half area of the arc tube main unit (ceramic tube) rather than downward from the arc tube main unit (ceramic tube).

The rectangular light source image a to be projected (stuck) radially on an area except the area along the cutoff lines has a width w2 greater than that of the rectangular light source image a to be projected (stuck) along the cutoff lines (w2>w1), so that uneven luminous intensity does not appear in the light distribution.

In accordance with one or more embodiments of the present invention, as a second aspect, the light shielding member is circumferentially extended from a first position substantially horizontal with respect to a discharge axis connecting the electrodes to a second position slanted approximately 15 degrees downward with respect to the discharge axis on an opposite side of the first position across the discharge axis.

(Working effect) The light shielding member covering the substantially lower half of the ceramic tube extends from a first position substantially horizontal with respect to a discharge axis connecting the counter electrodes to a second position slanted approximately 15 degrees downward with respect to the discharge axis on the opposite side across the discharge axis to form a sharp horizontal cutoff line and 15-degree slanting cutoff line about a cutoff line elbow part.

In accordance with one or more embodiments of the present invention, as a third aspect, at a tube end area of the ceramic tube including a pore communicating with the discharge light emitting chamber, an entire region of an outer peripheral surface of the tube end area and an end face of the tube end area is covered by the light shielding member.

(Working effect) In the arc tube main unit (ceramic tube), unlike a glass arc tube main unit where an arc alone mainly emits light, the entire arc tube main unit (ceramic tube) emits light. To design the effective reflecting (sticking) surface of a reflector, a rectangular light source image a corresponding to the outer shape of the entire arc tube main unit (ceramic tube) is radially projected about a cutoff line elbow part. At the center of the light source image a in longitudinal direction (section corresponding to the central area of the ceramic tube corresponding to the discharge light emitting chamber), the image uniformly emits light at a high brightness while at both ends of the light source image (sections corresponding to the end areas of the ceramic tube, the image emits light vaguely at a low brightness. Thus, in case a light source image a corresponding to the outer shape of the entire arc tube main unit (ceramic tube) is projected (stuck), the disparity in brightness on the light source image a appears as uneven luminous intensity in the light distribution with reduced forward visibility.

According to the third aspect, the outer peripheral surface of the arc tube main unit (ceramic tube) end area with low brightness is covered by a reflector. To design the effective reflecting surface of the reflector, only a rectangular light source image corresponding to the outer shape of the section corresponding to the central area of the arc tube main unit (ceramic tube) corresponding to the discharge light emitting chamber the entirety of which uniformly emits light at high brightness is projected (stuck) on a light distribution screen. The light distribution does not include uneven luminous intensity and forward visibility is preferable.

In accordance with one or more embodiments of the present invention, as a fourth aspect of the invention, the light shielding member comprises a light shielding member mounted on the ceramic tube, or a light shielding film formed in close contact with the ceramic tube.

(Working effect) The light shielding member mounted on the ceramic tube may be a white ceramic cap (for example a cap made of white ceramics with a reflectivity of 60 percent) or a metallic cap whose inner surface is a reflecting surface. The light shielding film formed in close contact with the ceramic tube may be an inorganic heat-resistant white coating formed on the outer surface of a ceramic tube or a dielectric multilayer film including layers with different refractive indexes formed on the outer surface of a ceramic tube. In nay form, a light shielding member covering the ceramic tube suppresses heat radiation from the ceramic tube thus improving the light emission efficiency (luminous flux/electric power).

In accordance with one or more embodiments of the present invention, as a fifth aspect of the invention, an automobile headlamp is provided with the discharge bulb according to any one of the first to fourth aspects and a reflector for controlling the light emission of the ceramic tube.

(Working effect) As described in relation to the working effects of the first to fourth aspects, as the luminous intensity of predetermined light distribution formed by a reflector increases, the light distribution hot zone approaches the cutoff line position (0.5 to 1.5D position).

As understood from the foregoing description, the discharge bulb according to the first aspect may be used as a light source of a headlamp thus providing a headlamp with both of the light distribution illumination (luminous intensity) and long distance visibility improved.

The discharge bulb according to the second aspect may be used as a light source of a headlamp to provide light distribution with a clear cutoff line and excellent long distance visibility.

The discharge bulb according to the third aspect may be used as a light source of a headlamp to form light distribution excellent in forward visibility with less conspicuous luminous intensity unevenness in the laterally diffused light distribution below the cutoff line.

The discharge bulb according to the fourth aspect suppresses heat radiation from the ceramic tube thus improving the light emission efficiency (luminous flux/electric power). Use of the discharge bulb as a light source of a headlamp further elevates the light distribution illumination (luminous intensity) of the headlamp.

The automobile headlamp according to the fifth aspect improves both the light emission efficiency (luminous flux/electric power) and long distance visibility.

Other aspects and advantages of the invention will be apparent from the following description and the appended claims.

### BRIEF DESCRIPTION OF THE DRAWINGS

FIG. 1 is a front view of an automobile headlamp that uses as a light source a discharge bulb as the first exemplary embodiment of the invention.

FIG. 2 shows a longitudinal cross-section in vertical direction of the headlamp taken along the line II-II in FIG. 1.

FIG. 3 shows an enlarged longitudinal cross-section in vertical direction of an arc tube as a key part of the discharge bulb.

FIG. 4 shows a transverse cross-section of the arc tube taken along the line IV-IV in FIG. 3.

FIG. 5(a) is an enlarged side view of a ceramic arc tube main unit.

FIG. 5(b) shows an enlarged longitudinal cross-section in vertical direction of the ceramic arc tube main unit.

FIG. 6 is a schematic view showing a process of designing the effective reflecting surface of a reflector.

FIG. 7 shows a light source image projected (stuck) on a light distribution screen in designing a reflector.

FIG. 8(a) shows an enlarged longitudinal cross-section in vertical direction of the arc tube main unit as a key part of the discharge bulb according to the second exemplary embodiment of the invention.

FIG. 8(b) shows an exploded schematic view of a reflective light shielding member covering the arc tube main unit.

FIG. 8(c) shows a cross-section taken along the line VIII-VIII in FIG. 8(a).

FIG. 9 shows a vertical cross section of a related art discharge bulb.

FIG. 10 shows a vertical cross section of a related art ceramic arc tube (JP-A-2001-076677).

FIG. 11 shows a vertical cross section of another related art ceramic arc tube (JP-A-2004-362978).

FIG. 12 shows a vertical cross section of a headlamp that uses the ceramic arc tube (JP-A-2004-362978) as a light source.

FIG. 13 shows a light source image projected (stuck) on a light distribution screen.

FIG. 14 shows a light distribution pattern formed on a light distribution screen.

### Reference Numerals and Characters

V1: Discharge bulb
10A: Arc tube
11A: Arc tube main unit
12: Ceramic tube
s: Discharge light emitting chamber
12a: Discharge light emitting part
12b: Constricted part
12c: Arc tube end area
14: Molybdenum pipe
14a: Laser welded part.
15, 15: Rod-shaped electrode
18a, 18b: Lead wire
20: Shroud glass for shielding ultraviolet rays
30: Synthetic resin insulating base
100: Reflector
101a: Effective reflecting surface
200: Reflective light shielding coat as a light shielding member
210: White ceramic cylinder as a light shielding member
CL, CLH: Cutoff line of a light distribution pattern formed on a light distribution screen
A (A1), C (C1):Light distribution pattern in an area along a cutoff line
B (B1): Light distribution pattern in an area other than the area along a cutoff line
a: Rectangular light source image projected on a light distribution screen
a1: Maximum luminance part in the rectangular light source image
w1: Width of a rectangular light source image projected (stuck) on an area along a cutoff line of a light distribution pattern
w2: Width of a rectangular light source image projected (stuck) on the area other than the area along a cutoff line of a light distribution pattern

### DETAILED DESCRIPTION OF THE EXEMPLARY EMBODIMENTS

Exemplary embodiments of the invention will be described with reference to the accompanying drawings.

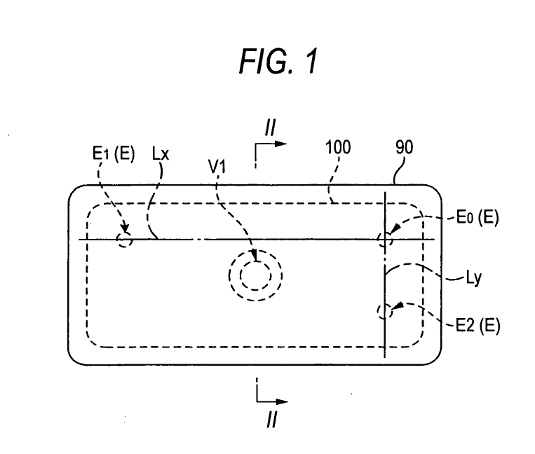

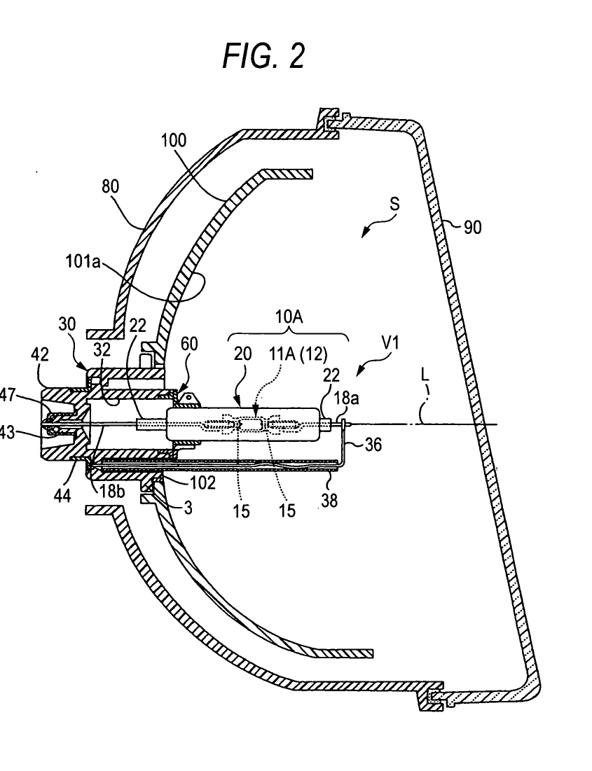

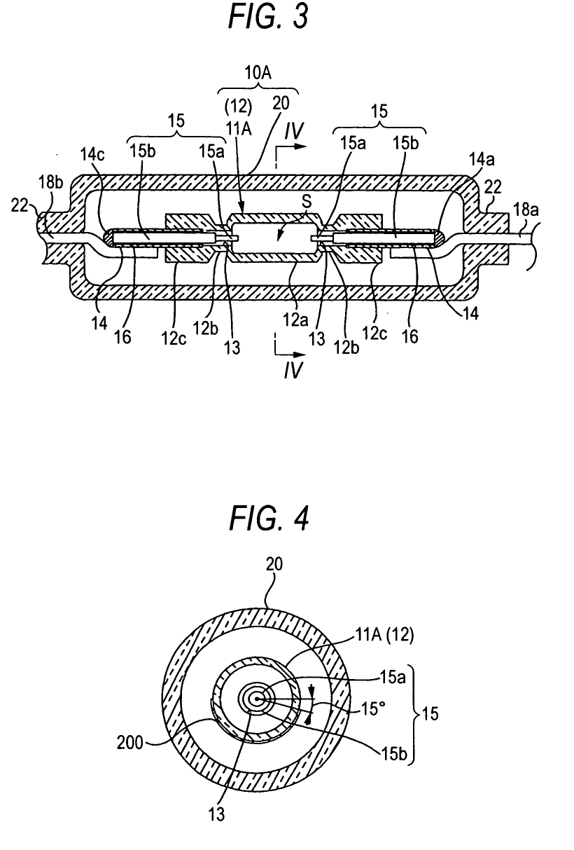

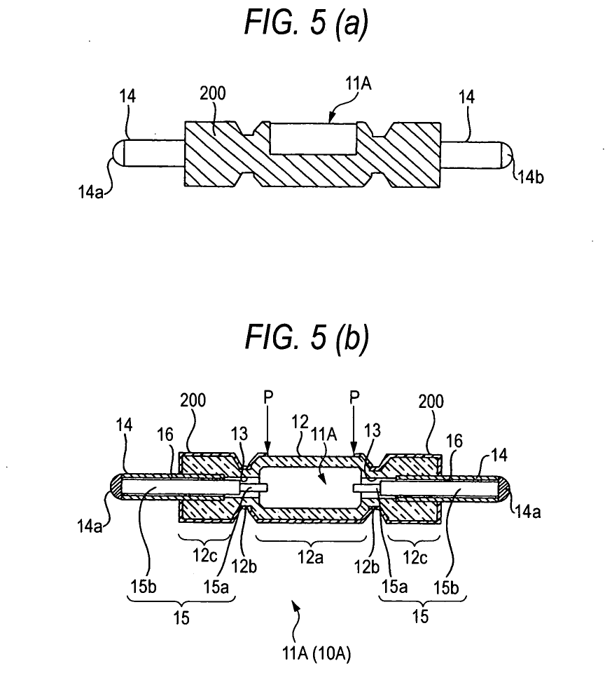

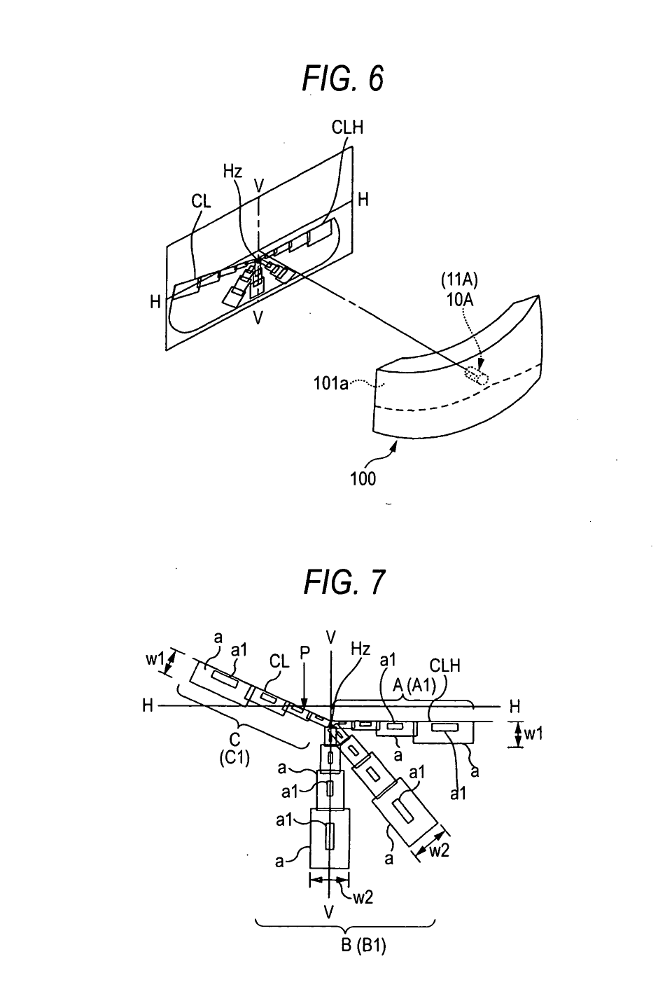

FIGS. 1 through 7 show a first exemplary embodiment of the invention. FIG. 1 is a front view of an automobile headlamp that uses as a light source a discharge bulb as the first exemplary embodiment of the invention. FIG. 2 shows a longitudinal cross-section in vertical direction of the headlamp taken along the line II-II in FIG. 1. FIG. 3 shows an enlarged longitudinal cross-section in vertical direction of an arc tube as a key part of the discharge bulb. FIG. 4 shows a transverse cross-section of the arc tube taken along the line IV-IV in FIG. 3. FIG. 5(a) is an enlarged side view of a ceramic arc tube main unit. FIG. 5(b) shows an enlarged longitudinal cross-section in vertical direction of the ceramic arc tube main unit. FIG. 6 is a schematic view showing a process of designing the effective reflecting surface of a reflector. FIG. 7 shows a light source image projected (stuck) on a light distribution screen in designing a reflector.

In these figures, a sign 80 represents the container-shaped lamp body of the automobile headlamp whose front side opens. To the front opening of the lamp body is assembled a transparent front cover 90 to partition a lamp chamber S. In the lamp chamber S is housed a reflector 100 with a discharge bulb V1 inserted into a bulb insert hole 102 at the rear apex. Inside the reflector 100 are formed an effective reflecting surface that is aluminum-evaporated. In particular, above the bulb insert hole 102 is arranged an effective reflecting surface 101a composed of multiple light distribution steps (multiple reflecting surfaces) having different curved surface shapes. Light emitted from the bulb V1 is reflected on (the effective reflecting surface 101a of) the reflector 100 and irradiated forward to form a predetermined light distribution pattern of the headlamp, as shown in FIG. 6.

As shown in FIG. 1, between the reflector 100 and the lamp body 80 are interposed an aiming fulcrum E0 of a single ball-joint structure and an aiming mechanism E composed of two aiming screws E1, E2 so as to tilt the optical axis L of the reflector 100 (headlamp) about a horizontal tilting axis Lx and vertical tilting axis Ly, that is, make so-called aiming adjustment of the optical axis L of the headlamp.

A sign 30 represents an insulating base composed of a PPS resin on the periphery of which is arranged a focus ring 34 engaged with the bulb insert hole 102 of the reflector 100. In the forward direction of the insulating base 30 is fixed and supported an arc tube 10A by a metallic lead support 36 as an energizing path extending forward from the base 30 and a metallic support member 60 fixed to the front surface of the base 30 to constitute a discharge bulb V1.

That is, a read wire 18a guided from the front end of the arc tube 10A is fixed by spot welding to the bent tip of the lead support 36 extending from the insulating base 30 so that the front end of the arc tube 10A is supported by the bent tip of the lead support 36. On the other hand, a read wire 18b guided from the rear end of the arc tube 10A is connected to a terminal 47 arranged at the rear end of the base 30 and the rear end of the arc tube 10A is grasped by a metallic support member 60 fixed to the front surface of the insulating base 30.

At the front end of the insulating base 30 is arranged a recess 32, in which the rear end of the arc tube 10A is housed and retained. At the rear end of the insulating base 30 is formed a cylindrical boss 43 enclosed by a cylindrical outer casing 42 extending rearward. On the outer periphery of the root part of the outer casing 42 is integrally fixed a cylindrical belt terminal 44 connected to the lead support 36. To the boss 43 is integrally stuck a cap terminal 47 to which the rear lead wire 18b is connected.

As shown in FIGS. 3 and 4, the arc tube 10A is composed of an arc tube main unit 11A including a discharge light emitting chamber s in which rod-shaped electrodes 15, 15 are provided face to face and a luminescent material such as a metal halide is filled together with a starting rare gas and cylinder-shaped shroud glass 20 for shielding ultraviolet rays covering the arc tube main unit 11A integrated with the arc tube main unit 11A. From the front/rear end of the arc tube main unit 11A are guided lead wires 18a, 18b electrically connected to the rod-shaped electrodes 15, 15 protruding into the discharge light emitting chamber s. The shroud glass 20 for shielding ultraviolet rays is sealed to the leadwires 18a, 18b to integrate the both components (arc tube main unit 11A and the shroud glass 20) to form the -arc tube 10A. A sign 22 represents a sealed part of the shroud glass 20 of which the diameter is contracted.

The arc tube main unit 11A includes a translucent ceramic tube 12 having a shape of a true cylinder whose external shape is uniform in longitudinal direction. At the center of the ceramic tube 12 in longitudinal direction is formed a discharge light emitting part 12a to partition a discharge light emitting chamber s. At each end of the ceramic tube 12 is formed a tube end area 12c including a pore 13 communicating with the discharge light emitting chamber s of the discharge light emitting part 12a.

Near the opening at the end of the pore 13 in the tube end area 12c is fixed a molybdenum pipe 14 by metallization jointing. From the end of the ceramic tube 12 protrudes the molybdenum pipe 14. The rod-shaped electrode 15 inserted into the molybdenum pipe 14 and whose tip protrudes into the discharge light emitting chamber s has its rear end welded (jointed) to the protruding tip of the molybdenum pipe 14 so as to be integral with the ceramic tube 12. A pore 13 communicating with the discharge light emitting chambers in which a luminescent material such as a metal halide is filled together with a starting rare gas is sealed. A sign 14a represents a laser welded part.

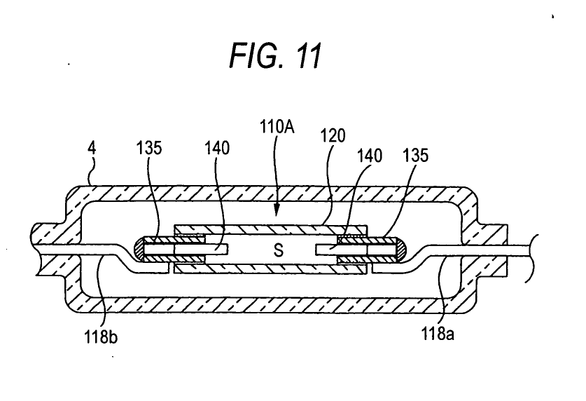

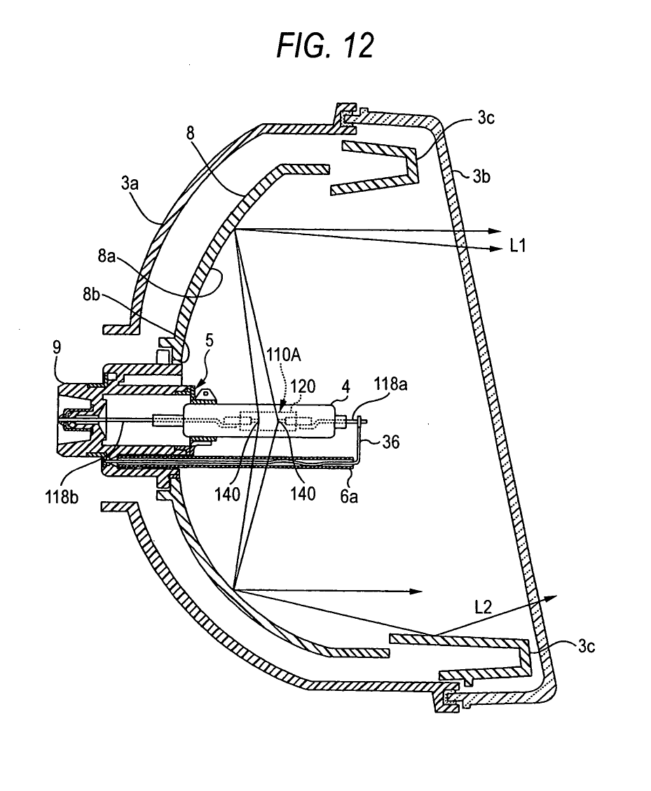

The ceramic tube 12 has the outer shape of its cross section orthogonal to the longitudinal direction formed uniformly in longitudinal direction. The thickness of the tube wall surrounding the pore 13 of the ceramic tube end area 12c is large thus in particular enhancing the thermal shock resistance of the ceramic tube end area 12c compared with the related art ceramic tube (refer to FIG. 11) where the entire tube wall is formed in nearly a uniform thickness.

The molybdenum pipe 14 is jointed to a position near the opening end of the pore 13. The insert tip of the molybdenum pipe 14 is placed at a position apart from the discharge light emitting chambers. Thus, heat from the discharge light emitting chamber s is more difficult to be transmitted to the molybdenum pipe 14 so that the thermal stress generated in the ceramic tube end area 12c is smaller than in the related art (refer to FIG. 7) where a molybdenum pipe is jointed to substantially the entire area of the pore 13 (the insert tip of the molybdenum pipe is in close proximity to the discharge light emitting chamber) . The ceramic tube end area 12c is less vulnerable to cracks.

Between the discharge light emitting part 12a as a central area of the ceramic tube and the tube end area 12c is circumferentially arranged a constricted part 12b for reducing the thickness of a tube wall surrounding the pore 13 and suppressing heat transmission from the discharge light emitting part 12a to the tube end area 12c thus enhancing the thermal shock resistance in the tube end area 12c as well as increasing the light emission efficiency in the discharge light emitting part 12a.

In other words, the thickness of the tubewall corresponding to the constricted part 12b is smaller than that of the tube end area 12c. The thickness of the heat transmission path from the ceramic tube central area (discharge light emitting part) 12a to the tube end area 12c is reduced to suppress heat transmission from the ceramic tube central area (discharge light emitting part) 12a to the tube end area 12c. The amount of heat transmission to the tube end area 12c is reduced so that the tube end area 12c is not heated to a higher temperature and the thermal stress generated in the ceramic tube end area 12c where the molybdenum pipe is jointed by metallization is small and the thermal shock resistance of the tube end area 12c is high.

Heat transmission from the ceramic tube central area (discharge light emitting part) 12a to the tube end area 12cis suppressed so that the temperature in the discharge light emitting chamber s is maintained thus improving the light emission efficiency (luminous flux value with respect to power consumption) of the arc tube main unit 11A.

In particular, the constricted-part 12b is arranged in the part between the insert tip of the molybdenum pipe 14 and the discharge light emitting chamber s (the insert tip of the molybdenum pipe 14 does not extend to the position corresponding to the constricted part 12b) . The heat transmission suppressing effect of the reduced tube wall thickness remains active without being hindered by the molybdenum pipe 14 with good thermal conductivity.

The thickness of the ceramic tube end area 12c is augmented so that the volume (weight) of the ceramic tube 12 increases, which correspondingly adds to the thermal capacity of the ceramic tube 12. However, by the provision of the constricted part 12b between the discharge light emitting part 12a and the tube end area 12c, the volume (weight) of the ceramic tube 12 is reduced, and thereby the thermal capacity of the ceramic tube 12 is correspondingly reduced. That is, the increase and decrease in the thermal capacity of the ceramic tube 12 offset each other. The thermal capacity of the ceramic tube 12 does not show a considerable change when compared with the related art ceramic tube (refer to FIG. 11).

On the outer peripheral surface and end face of the tube end area 12c including the substantially lower half area of the outer peripheral surface of the discharge light emitting part 12a and the constricted part 12b of the ceramic tube 12 is formed a reflective light shielding coat 200 in order to increase the amount of outgoing light from the area without a reflective light shielding coat formed thereon above the discharge light emitting part 12a and raise the light distribution illumination (luminous intensity) of a headlamp as well as prevent generation of glare light by interrupting light emission in the tube end area 12c. That is, the reflective light shielding coat 200 at the discharge light emitting part 12a is provided so as to extend circumferentially from a first position substantially horizontal with respect to a discharge axis connecting the counter electrodes 15, 15 to a second position slanted approximately 15 degrees downward with respect to the discharge axis on the opposite side across the discharge axis thus forming sharp cutoff lines (horizontal cutoff line and 15-degree slanting cutoff line) about a cutoff line elbow part in the light distribution of low beams. Light emitted downward from the discharge light emitting part 12a is reflected on the reflective light shielding coat 200 and is returned to the discharge light emitting part 12a, and then emitted from the area without a reflective light shielding coat formed thereon in the discharge light emitting part 12a toward the effective reflecting surface 101a of the reflector 100, thus increasing the brightness in the discharge light emitting part 12a.

The reflective light shielding coat 200 is accurately formed so that the side edge on side of the discharge light emitting part 12a of the reflective light shielding coat 200 formed on the outer peripheral surface of the tube end area 12c will sit within the range of ±0.5 mm in the axial direction of the position P corresponding to the tip of the rod-shaped electrode 15 in order to prevent generation of glare light from faint light (outgoing light as diffused light specific to a ceramic tube 12) in the areas 12b, 12c of the ceramic tube 12 except the discharge light emitting part 12a.

The reflective light shielding coat 200 as a light shielding member is formed on the ceramic tube 12 so that heat radiation from the ceramic tube 12 is suppressed and the light emission efficiency at the discharge light emitting part 12a is accordingly improved.

The reflective light shielding coat 200 may be a dielectric multilayer film including layers with different refractive indexes (for example a multilayer film 10 to 20 μm thick where a layer of Ta₂O₅ and a layer of SiO₂ are laminated alternately or where a layer of TiO and a layer of SiO₂ are laminated alternately). Or, the light shielding coat 200 may be an inorganic white coating with baked-on finish (for example, a coat of a mixture of K₂SiO₃, Al₂0₃ and an aqueous solvent, or a mixture of Al₂0₃, ZrO₂, TiO₂, alcohols and a binder (coat of organosiloxane condensate). Any type of coat satisfies the four conditions: heat resistance to 800 to 1000 degrees Celsius, reflectivity to reflect visible light, good contact with the ceramic tube 12, and a thermal expansion coefficient close to that of the ceramic tube 12 (8.1×10⁻⁶).

The rod-shaped electrode 15 is a tungsten electrode rod 15a with a small diameter on the tip side coaxially and integrally jointed with a molybdenum rod 15b with a large diameter on the rear side. Between the molybdenum pipe 14 and (the molybdenum rod 15b of) the rod-shaped electrode 15 is formed a micro-space 16 of for example about 25 micrometers so as to allow insertion of the rod-shaped electrode 15 and absorb the thermal stress generated at both ends of the ceramic tube 12. To the molybdenum pipe 14 protruding from the ceramic tube 12 are fixed the bent tip parts of the lead wires 18a, 18b and the lead wires 18a, 18b and the rod-shaped electrodes 15, 15 are arranged on the same axis (refer to FIG. 3).

Light distribution formed by the headlamp according to this exemplary embodiment will be detailed.

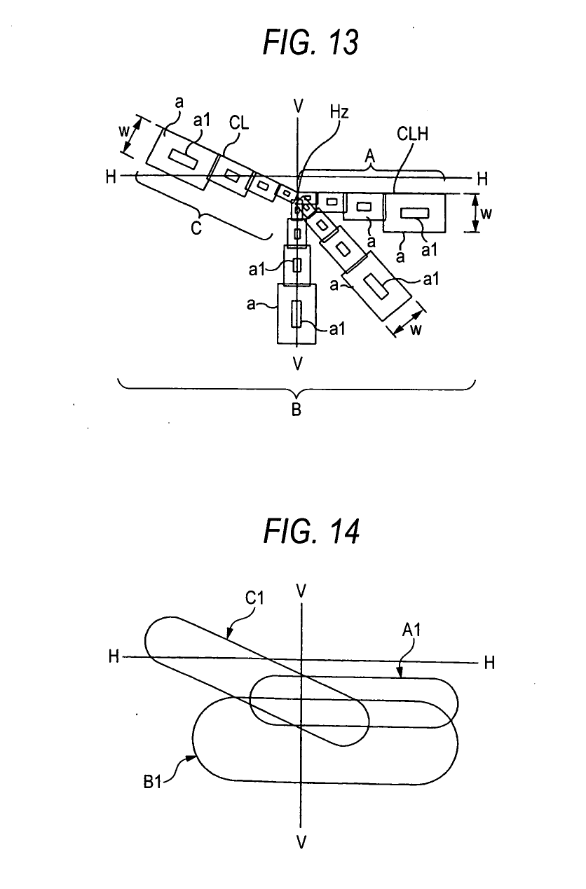

As shown in Figs. 6 and 7, to design the effective reflecting surface 101a of the reflector 100, a rectangular light source image a corresponding to the outer shape of the arc tube 11A is radially projected (stuck) about a cutoff line elbow part on a light distribution screen disposed at a position frontward of the reflector 100, similar to the related art method shown in FIGS. 13 and 14. The substantially lower half of the outer peripheral surface of the arc tube 11A (discharge light emitting part 12c) is covered by the reflective light shielding coat 200 so that the following characteristics are observed.

In the first place, a light source image forming the light distribution patterns A (A1), C (C1) in the area along the cutoff lines CL, CLH, that is, a rectangular light source image a to be projected (stuck) along the cutoff lines CL, CLH is made slimmer (narrower). The size of the rectangular light source image a with respect to the maximum luminance part (section corresponding to the arc formed between electrodes) a1 is made slimmer, that is, the width w1 of the rectangular light source image a is reduced (w1<w) in the case of an arc tube without a reflective light shielding coat as shown in FIG. 13. Further, the maximum luminance part a1 is positioned close to the upper edge of the rectangular light source image a. This makes it possible to perform light distribution design (of the effective reflecting surface 101a of the reflector 100) so as to allow the maximum luminance part a1 to approach the cutoff lines CL, CLH. As a result, the light distribution hot zone Hz gets closer to the cutoff lines CL, CLH (0.5 to 15.D position).

In the second place, light emitted downward from the arc tube 12 is reflected on the reflective light shielding coat 200 and is returned into the arc tube 12 and emitted from substantially the upper half area of the arc tube 12 not covered by the reflective light shielding coat 200. This increases the brightness of each rectangular light source image a radially projected (stuck) about a cutoff line elbow part thus adding to the luminous intensity of light distribution formed by the effective reflecting surface 101a of the reflector.

In the third place, a light source image (rectangular light source image radially projected (stuck) about the cutoff elbow part) forming light distribution patterns A (A1), B (B1), C (C1) has a part corresponding to the tube end area 12c vaguely emitting light light-shielded by the reflective light shielding coat 200 to appear as a rectangular light source image with high luminous intensity corresponding to the discharge light emitting part 12a. Further, the rectangular light source image projected (stuck) to the area other than the area along the cutoff lines CL, CLH is not a slim (narrow) light source image (with a width w) projected (stuck) to the area along the cutoff lines CL, CLH but an image with a width w2 (>w1) corresponding to the tube diameter of the arc tube 12. As a result, more areas overlap other light source images adjacent to the periphery of the elbow part and the disparity in color or brightness between respective light source images a, a is smoothed to form light distribution where uneven color and luminous intensity is less conspicuous.

In this way, according to the headlamp of this exemplary embodiment, light to be emitted downward from the discharge light emitting part 12a is also emitted upward and reflected on the effective reflecting surface 101a of the reflector to form low-beam light distribution. This results in a higher light distribution illumination (luminous intensity) of the headlamp. The hot zone comes close to the cutoff line CL (0.5 to 15.D position) so that light distribution with high long distance visibility is obtained. Further, uneven color and luminous intensity is less conspicuous in the laterally diffused light distribution below the cutoff line CL at a position frontward of the vehicle thus obtaining light distribution with high forward visibility.

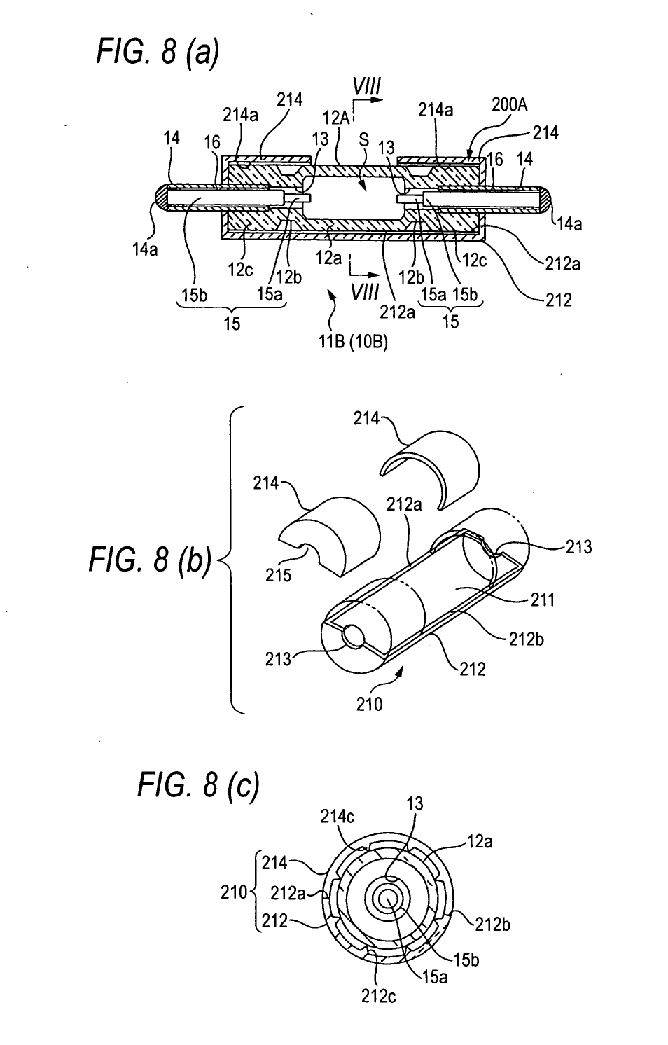

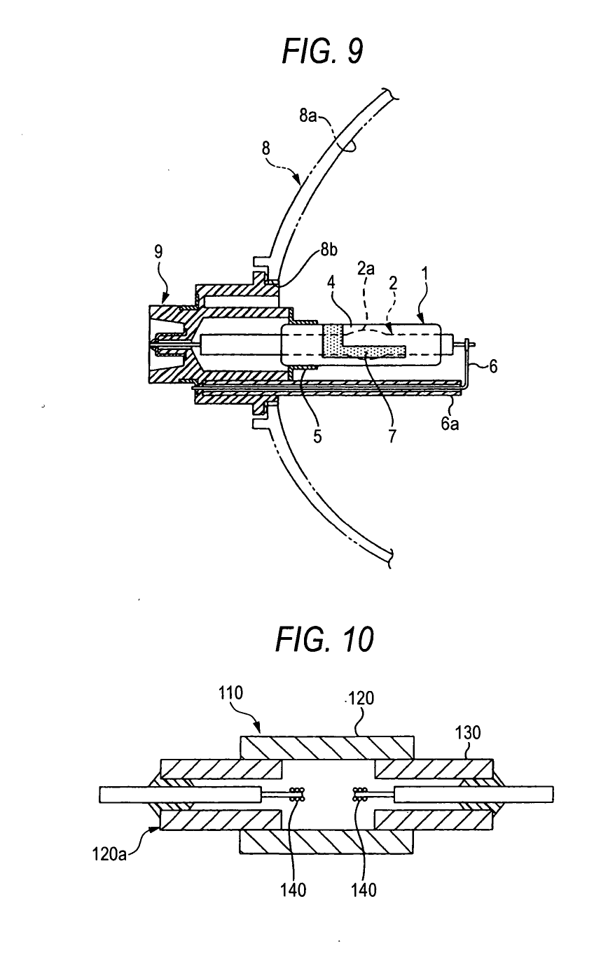

FIG. 8(a) to 8(b) shows an arc tube main unit as a key part of the discharge bulb according to a second exemplary embodiment of the invention. FIG. 8(a) shows an enlarged longitudinal cross-section in vertical direction of the arc tube main unit. FIG. 8(b) shows an exploded schematic view of a reflective light shielding member covering the arc tube main unit. FIG. 8(c) shows a cross-section taken along the line VIII-VIII in FIG. 8(a).

In the first exemplary embodiment, the reflective light shielding coat 200 is formed on the ceramic tube 12 to raise the light distribution illumination (luminous intensity) of the headlamp as well as prevent generation of glare light by interrupting outgoing light from the tube end area 12c. In the second exemplary embodiment, the ceramic tube 12 is covered by a partially notched white ceramic cylinder 210 to raise the light distribution illumination (luminous intensity) of the headlamp as well as prevent generation of glare light by interrupting outgoing light from the tube end area 12c.

In other words, the ceramic cylinder 210 (cylinder lower body 212, cylinder upper body 214) is composed of white ceramics with a reflectivity of 60 percent and has a function to reflect light toward the inner surface and a function to shield part of outgoing light (transmitted light). The cylinder 210 includes an opening (notch) 211 corresponding to the are without a reflective light shielding coat where the reflective light shielding coat 200 is not formed according to the first exemplary embodiment and is composed of a cylinder lower body 212 enclosing the substantially lower half area of the ceramic tube 12 and a pair of cylinder upper bodies 214 enclosing substantially the upper half of the end area 12b of the ceramic tube 12. The side edges 212a, 212b of the cylinder lower body 212 constituting the opening (notch) 211 are at a position horizontal with respect to the a discharge axis connecting the counter electrodes 15, 15 and at a position slanted approximately 15 degrees downward with respect to the discharge axis to form a sharp horizontal cutoff line CLH and 15-degree slanting cutoff line CL about a cutoff line elbow part in the low beam light distribution.

On the end face walls of the cylinder lower body 212 and the cylinder upper body 214 are provided circular recessed parts 213, 215 engaged with a molybdenum pipe 14 protruding from the ceramic tube 12. By housing the arc tube main unit 11A in the cylinder lower body 212 and bonding the cylinder upper body 214 to the cylinder lower body 212 with an adhesive so as to cover the arc tube main unit 11A, the ceramic cylinder 210 is integrated into a form that covers the ceramic tube 12 of the arc tube main unit 11A.

On the inner peripheral surface 210 (cylinder lower body 212, cylinder upper body 214) are arranged circumferentially at equal pitches to form a space between the arc tube 12 and the ceramic cylinder 210 thus suppressing the increase in the thermal capacity of the ceramic tube 12. That is, close contact of the inner peripheral surface 210 (cylinder lower body 212, cylinder upper body 214) with the outer peripheral surface of the ceramic tube 12 results in a substantial increase in the thermal capacity of the ceramic tube 12 by a volume (weight) corresponding to the ceramic cylinder 210, which could accordingly degrade the initial characteristics of the discharge bulb. In reality, a heat insulating space formed between the arc tube 12 and the ceramic cylinder 210 prevents the thermal capacity of the arc tube 12 from being substantially increased. As a result, the initial characteristics of the discharge bulb are not degraded.

In the second exemplary embodiment, a metallic cylinder with a reflecting surface inside that is aluminum-evaporated may be used in place of the ceramic cylinder 210 composed of white ceramics.

While each of the first and second discharge bulbs according to the first and second exemplary embodiments has a structure where the ceramic arc tube main units and the shroud glass enclosing the arc tube main units are integrated together before the insulating base 30 in the first and second exemplary embodiments, the arc tube main units arranged before the insulating base 30 may be ceramic arc tube main units without a shroud glass.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A discharge bulb comprising:
a ceramic arc tube;
a discharge light emitting chamber formed on the ceramic arc tube, wherein electrodes are provided face to face and a luminescent material is filled in the discharge light emitting chamber; and
a light shielding member that covers at least substantially lower half of an outer peripheral surface of the ceramic tube constituting the ceramic arc tube and reflects light toward an inner surface.

2. The discharge bulb according to claim 1, wherein the light shielding member is circumferentially extended from a first position substantially horizontal with respect to a discharge axis connecting the electrodes to a second position slanted approximately 15 degrees downward with respect to the discharge axis on an opposite side of the first position across the discharge axis.

3. The discharge bulb according to claim 1, wherein, at a tube end area of the ceramic tube including a pore communicating with the discharge light emitting chamber, an entire region of an outer peripheral surface of the tube end area and an end face of the tube end area is covered by the light shielding member.

4. The discharge bulb according to claim 1, wherein the light shielding member comprises a light shielding member mounted on the ceramic tube.

5. The discharge bulb according to claim 1, wherein the light shielding member comprises a light shielding film formed in close contact with the ceramic tube.

6. An automobile headlamp comprising the discharge bulb according to claim 1 and a reflector for controlling the light emission of the ceramic tube.
